(19) United States
(12) Patent Application Publication
(10) Pub. No.: US 2014/0139195 A1
(43) Pub. Date: May 22, 2014

(54) VOLTAGE REGULATOR DEVICE

(71) Applicants: Andrea Bellomini, Pontedera (Pisa) (IT); JeanPaul Milani, Ponterdera (Pisa) (IT)

(72) Inventors: Andrea Bellomini, Pontedera (Pisa) (IT); JeanPaul Milani, Ponterdera (Pisa) (IT)

(21) Appl. No.: 14/131,457

(22) PCT Filed: Jul. 23, 2012
(86) PCT No.: PCT/EP2012/064375

§ 371 Date: Jan. 8, 2014

(30) Foreign Application Priority Data
Jul. 26, 2011 (IT) MI2011A001395

(51) Int. Cl. H02P 9/48; H02P 9/08

(52) U.S. Cl. CPC H02P 9/48; H02P 9/08
USPC 322/28

(57) ABSTRACT

A voltage regulator device (10) is described, applicable to the electrical system of a motor vehicle of the type comprising at least an electrical machine consisting of a three-phase generator and at least an accumulator (12). The voltage regulator device (10) comprises a rectifier bridge and a voltage rising circuit (16) provided with a first series of power elements (20). The voltage rising circuit (16) comprises one or more inductors (14) the winding inductance of stator phase of which is exploited in order to raise the phase voltage above the level of the voltage provided by the accumulator (12), so that it is possible to supply current to the electrical loads of the vehicle since a very low rotation regime of the engine of the vehicle itself.

The present invention relates to a voltage regulator device, in particular applicable to the electrical system of a motor vehicle, such as a motor cycle.

A voltage regulator or stabilizer is a device intended to be interposed between an electrical power generator and one or more electrical loads. The voltage regulator or stabilizer receives an input voltage having a variable value in a preset time period, and produces an output voltage having a preset, accurate, and stable value, independently from the current intensity absorbed by the electrical load.

The electrical and electronic components of the motor vehicles in general, with particular reference to the motor cycles, are usually capable of absorbing a maximum voltage that is not particularly high, and can also be severely damaged by a voltage oscillation. Vice versa, a voltage lowering can involve a power supply that is insufficient for the proper functioning of the vehicle. Therefore, the use of voltage regulators on the motor vehicle allows maintaining a voltage within the range that the electrical or electronic component of the vehicle itself can accept without incurring in malfunctionings.

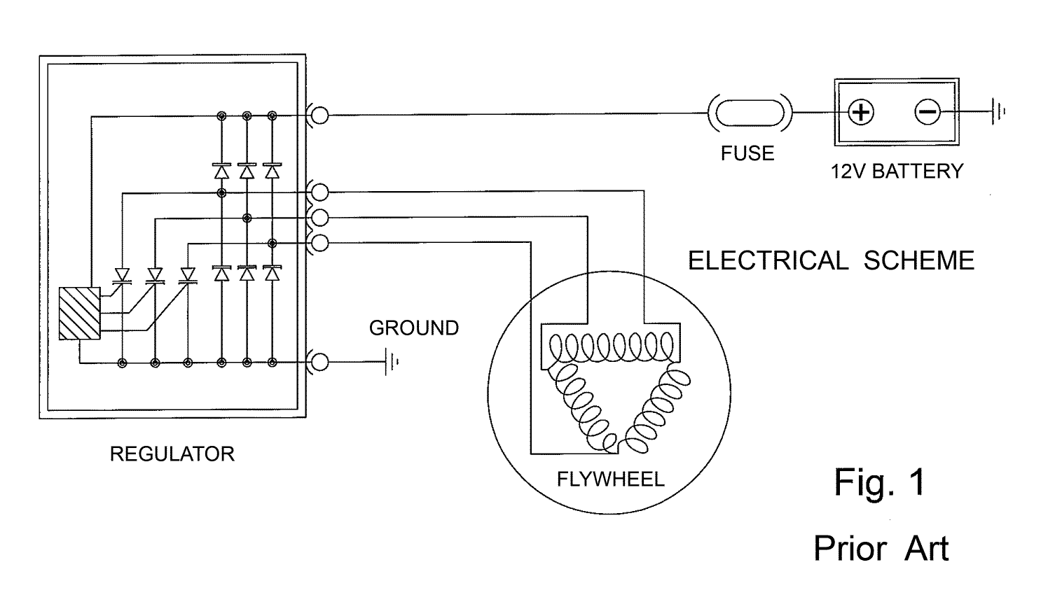

The state of the art for the shunt voltage regulators for automotive applications provides for the use of a diode bridge in order to convert the signals provided by the three-phase voltage generator, dragged by the endothermic engine of the vehicle, into a continuous voltage, to be able to recharge the accumulator (battery) that is present on the vehicle itself. Such a voltage regulator is represented by the principle scheme shown in the following FIG. 1.

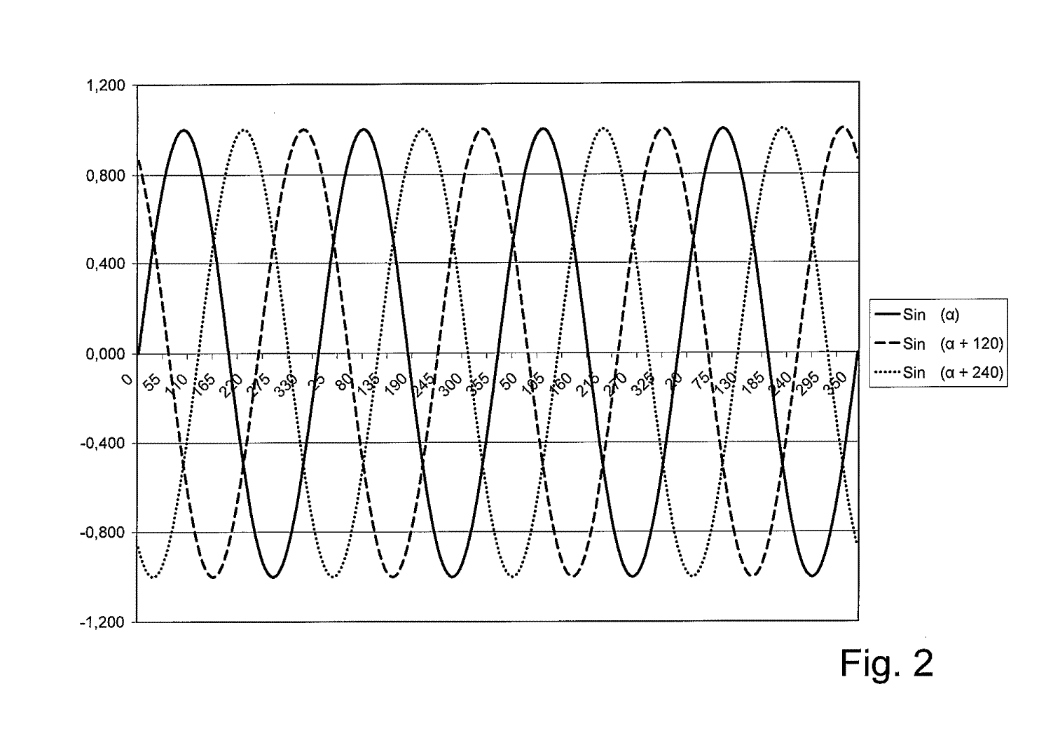

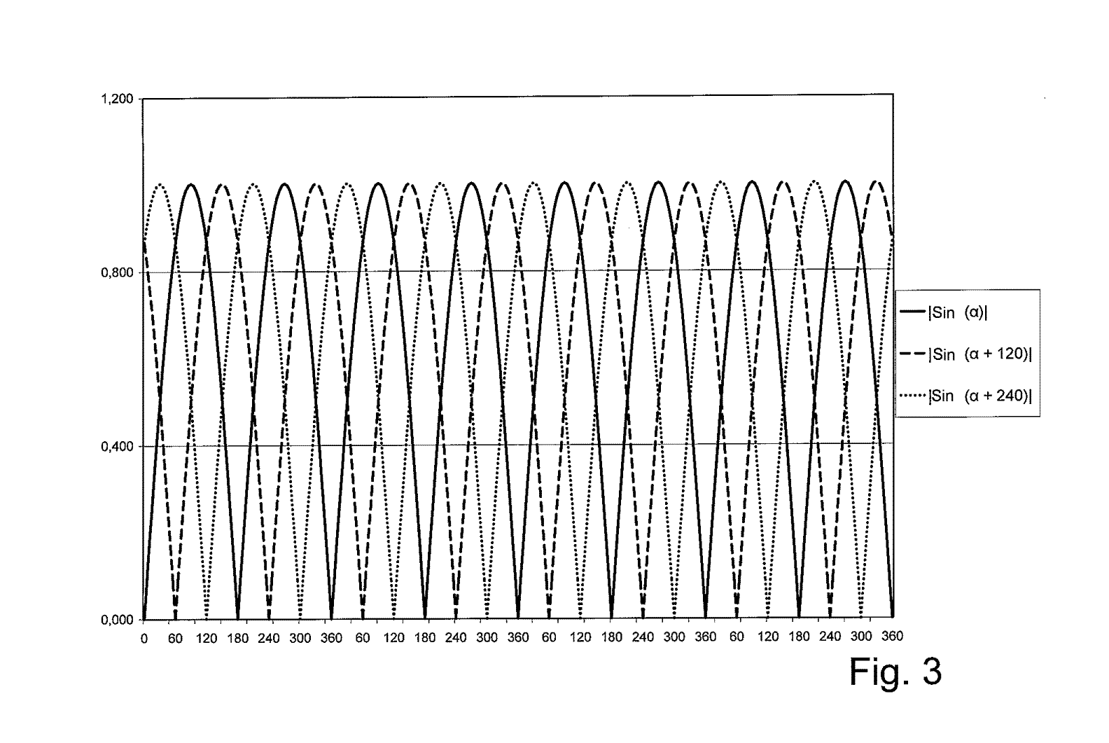

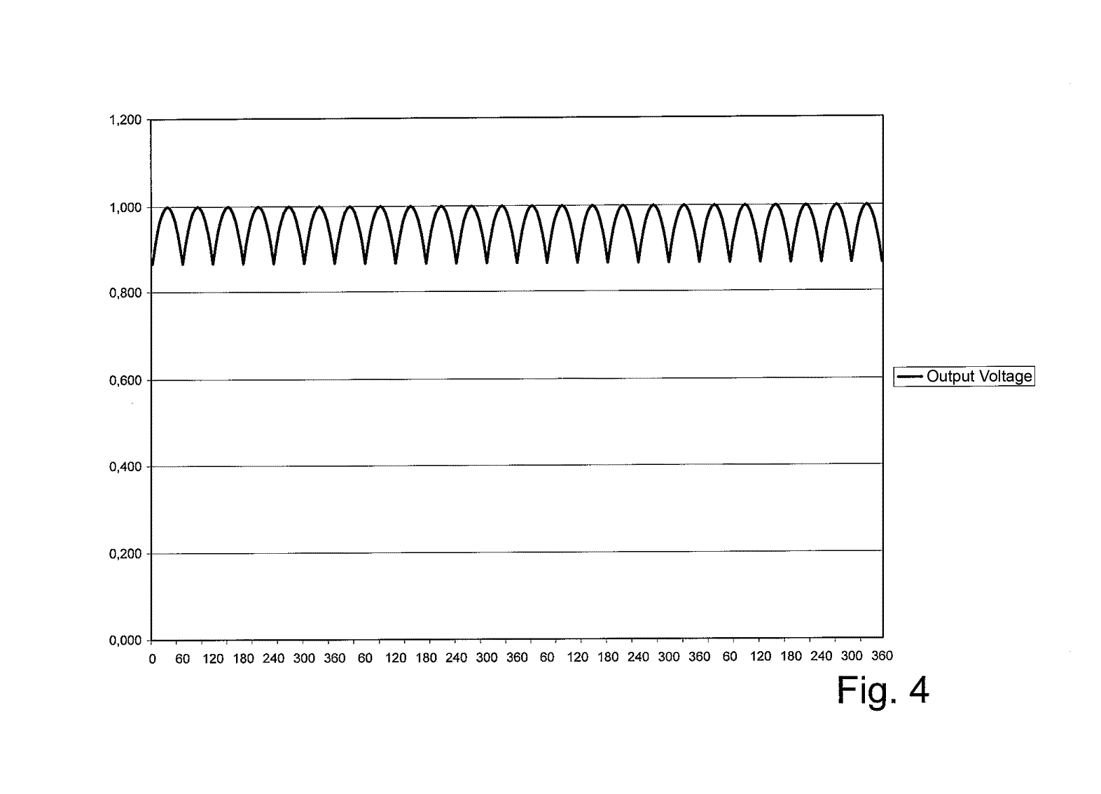

In FIG. 2, the variation in time of the three sinusoidal waves produced by the vehicle voltage generator is schematized. These sinusoidal waves turn out to be mutually offset by 120°. These sinusoidal signals are made completely positive by the use of the three-phase diode bridge, thus obtaining for each phase the signal trend as illustrated in FIG. 3. Since the diode bridge acts as an envelop detector, the obtained exiting waveform is the one represented in FIG. 4.

The management of the regulation takes place by means of three further power elements, such as, for example, thyristors or SCR (“Silicon Controlled Rectifiers”), which are activated upon reaching the maximum voltage of the battery and which provide to short-circuit to ground, throughout the entire duration of a half wave, the voltage generator. In this manner, no further energy is supplied to the battery, an the voltage of the battery itself does not rise further.

The main drawback of the voltage generators of the known type is due to a low efficiency, relating to all three operative phases of the voltage generator, that is:

1) during the power supply phase towards the battery, where there is a yield ranging between 70% and 80% due the voltage loss that takes place on the diodes of the bridge, that are run through by the entire current provided by the generator;

2) during the regulation phase, where a mechanical power loss takes place, since the entire current provided by the generator run through the control thyristors. The mechanical power loss is internally dissipated in the form of heat;

3) during the ignition phase, where the generator voltage does not exceed the battery voltage level and it is not possible to supply energy towards the battery itself, since the diodes of the rectifier bridge are in a condition of inverse biasing, therefore they are prevented from conducting.

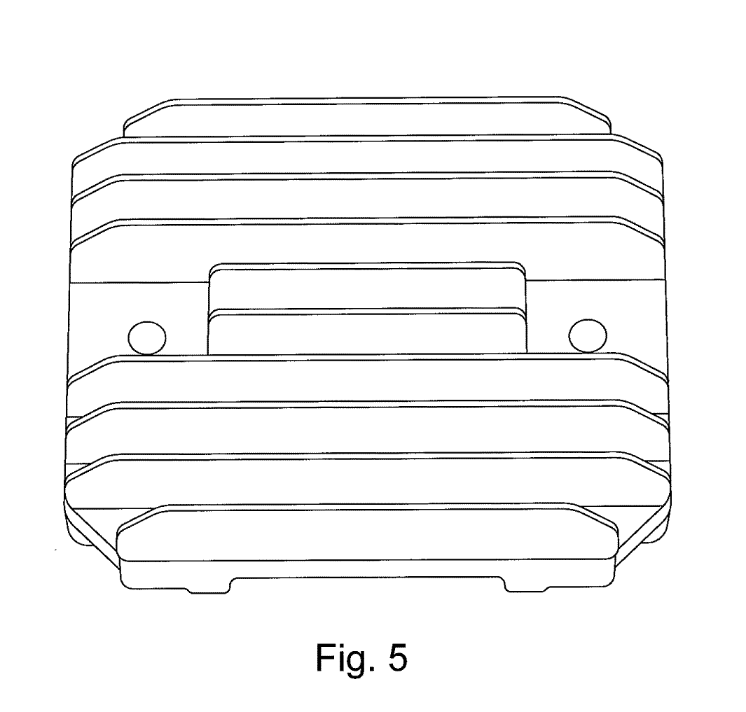

The consequence of the first two aspects is that the electrical energy generation system installed on the motor vehicles has to be oversized compared to the real needs, so as to account for the losses in the voltage regulation system, with a consequent increase in the fuel consumptions and pollutant emissions. In addition, the voltage regulator devices of the known type need a suitable heat dissipation apparatus, such as, for example, the one shown in FIG. 5.

Instead, this latter aspect limits the possibility to produce engines with a low minimum regime, as well as the possibility to start electronic injection-supplied vehicles, in the absence of a battery, by means of the use of kick-starters. This latter problem relates in particular to motor cycles and mopeds.

Therefore, the object of the present invention is to produce a voltage regulator device, applicable in particular to the electrical system of a motor vehicle, which is capable of solving the above-mentioned drawbacks of the prior art in an extremely simple, economic, and particularly functional manner.

In detail, it is an object of the present invention to produce a voltage regulator device that is capable of transferring almost entirely the energy available from the electrical machine (generator) towards the battery.

Another object of the invention is to produce a voltage regulator device that avoids dissipating energy on the diodes of the rectifier bridge, thus reducing the voltage loss on the power elements.

Another object of the invention is to produce a voltage regulator device that does not need particularly complex and bulky heat dissipation systems.

These objects according to the present invention are achieved by producing a voltage regulator device, applicable in particular to the electrical system of a motor vehicle, as set forth in claim 1.

Further characteristics and advantages of a voltage regulator device according to the present invention are highlighted by the following description, given by way of non-limiting example, with reference to the annexed schematic drawings, in which:

FIG. 1 shows the principle scheme of a voltage regulator device produced according to the prior art;

FIG. 2 is a graph illustrating the variation in time of the three sinusoidal signals produced by the voltage generator of a general motor vehicle;

FIG. 3 is a graph illustrating the signals of FIG. 2 after they have been rectified by a three-phase diode bridge;

FIG. 4. is a graph illustrating the waveform of the output voltage from the voltage regulator device of FIG. 1;

FIG. 5 illustrates a heat dissipation element, applicable to a voltage regulator device as that shown in FIG. 1;

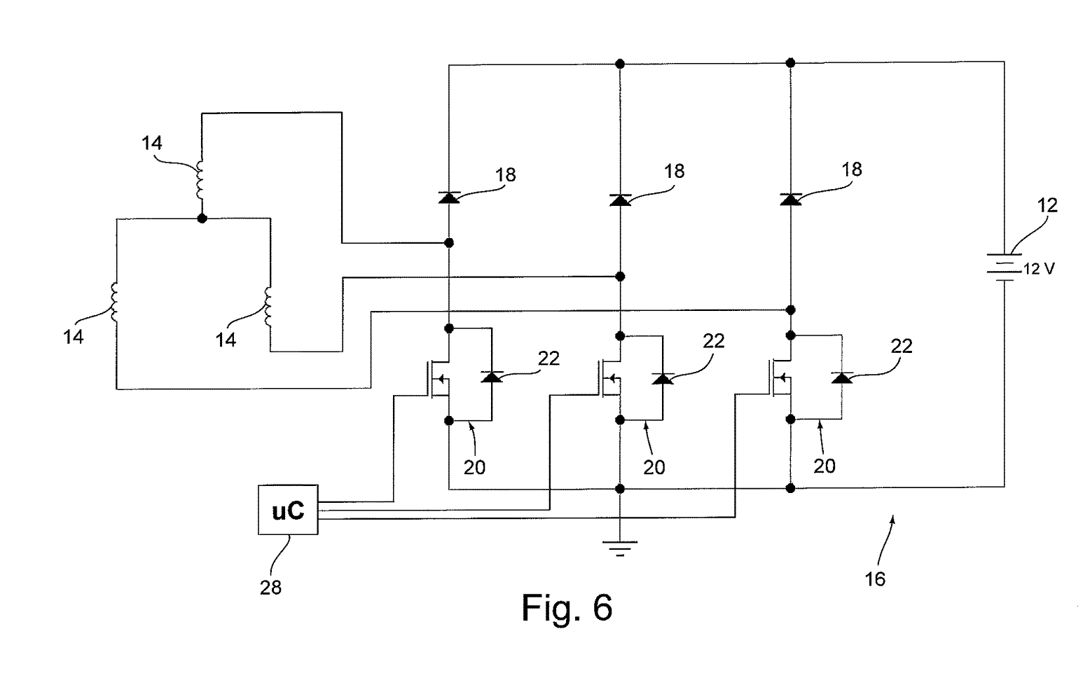

FIG. 6 illustrates a step-up circuit, o voltage rising circuit, applicable to a voltage regulator device according to the present invention;

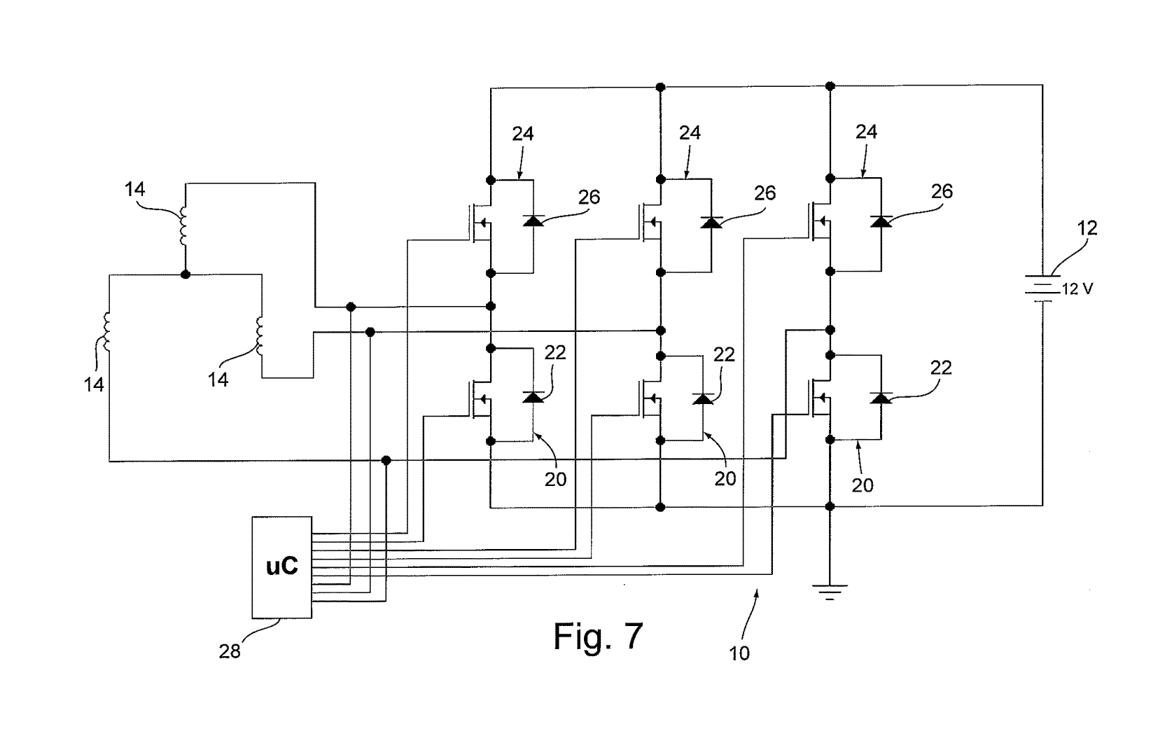

FIG. 7 illustrates the entire circuit of the voltage regulator device according to the present invention; and

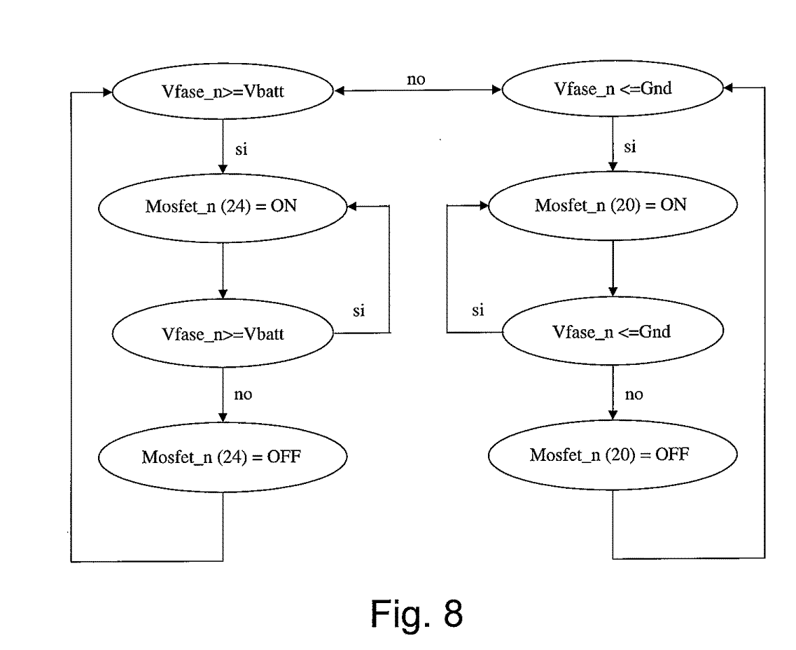

FIG. 8 is a block scheme illustrating the functioning of the voltage regulator device according to the present invention.

With particular reference to FIGS. 6 to 8, a voltage regulator device according to the present invention is shown, applicable in particular to the electrical system of a motor vehicle, in particular a motor cycle, and generally indicated with the reference number 10. In detail, the electrical system of the motor vehicle is of the type comprising at least one electrical machine (not shown), typically a three-phase generator (alternator), and at least one accumulator 1, such as, for example, a common 12 Volt battery.

In order to optimize the battery recharge system 12 to a minimum rotation regime of the vehicle, it is necessary to transfer almost entirely the energy available from the electrical machine towards the battery 12 itself. This is obtained by exploiting, in the voltage regulator device 10 according to the invention, the winding inductance of stator phase of one or more inductors 14 to implement a step-up circuit 16, or voltage riser, which allows rising the phase voltage above the level of the voltage provided by the battery 12, so that it is possible to supply current to the electrical loads of the vehicle since a very low rotation regime of the engine, according to the principle scheme shown in FIG. 6.

Substantially, during the closure of the switch on the lower part of the rectifier bridge, energy is stored in the inductors 14. This energy is returned to the opening of the switch as an extra voltage, allowing triggering the three diodes 18 that are present in the upper part of the rectifier bridge, therefore allowing supplying energy towards the battery 12.

The step-up circuit 16 has to be produced with power elements 20, controllable at any time, both in closing and opening, on the lower part of the rectifier bridge, as well as the above-mentioned diodes 18 arranged in the upper part of the rectifier bridge. According to the invention, such power elements 20 consist of a first series of three N channel field-effect transistors of the MOSFET type, wherein it is possible to use the respective wheeling diodes 22 as rectifier elements and the channel closure in order to perform the regulating and raising voltage functions (step-up) according to the principle scheme shown in FIG. 6.

In order to optimize the yield of the voltage regulator device 10 during the functioning, a measure has been introduced to avoid dissipating energy on the diodes 18 of the rectifier bridge, by reducing the voltage loss on the power elements.

This measure provides that also in the upper part of the rectifier bridge a second series of power elements 24 is provided for, that consist of three N channel field-effect transistors of the MOSFET type, according to the principle scheme shown in FIG. 7. Among such field-effect transistors of the MOSFET type 24, it is possible to use the wheeling diodes 26 as rectifier elements during the step-up phase. Instead, the wheeling diodes 26 are by-passed at the end of the step-up phase.

Substantially, when exceeding the rotation regime value of the engine beyond which the step-up measure does not contribute anymore, the first MOSFET series 20 and the second MOSFET series 24 of the rectifier bridge are driven in a synchronous manner with the three half waves generated by the three-phase generator.

Each MOSFET 20, 24 is driven with a separate drive in the instant when the relative wheeling diode 22, 26 would come into direct conduction.

In this manner, the conventional diodes are replaced by elements at a very low resistance, which drastically reduce the energy dissipated on the rectifier bridge, thus increasing the yield of the voltage regulator device 10. With this type of drive, yields can be achieved that can exceed 95%, which allows, while keeping the energy supplied by the accumulator 12 constant, using cooling systems that are drastically more reduced compared to the voltage regulators produced according to the conventional technique.

In order to be able to implement all the functions described above, the voltage regulator device 10 according to the invention is provided with both a microprocessor 28 generating the necessary drives for each MOSFET 20, 24, and with specific interface drivers for driving the upper part and the lower part of the rectifier bridge. The algorithm used to drive the MOSFETs 20, 24 when the wheeling diodes 22, 26 are proximate to the direct conduction is indicated in FIG. 8. This algorithm provides for a synchronous drive of each MOSFET 20, 24, where the generator of the rectifier bridge is implemented as follows:

if the voltage phase V_{fase}_{_{—}}ₙ in the voltage regulator device 10 is greater than or equal to the positive potential V_{batt} of the battery 12, the first series of MOSFETs 20 is switched off, so as not to short-circuit the battery 12, and the second series of power elements 24 is switched on, so that the current can flow from the generator towards the battery 12 through a low resistance path, as the MOSFETs 24, and not through the wheeling diodes 26.

Similarly, if the voltage phase V_{fase}_{_{—}}ₙ in the device 10 is lower than or equal to the negative potential G_{batt} of the battery 12, the second series of MOSFETs 24 is switched off, so as not to short-circuit the battery 12, and the first series of MOSFETs 20 is switched on, so that the current can flow from the generator towards the battery 12 through a low resistance path, as the MOSFETs 20, and not through the wheeling diodes 22.

In this manner, it has been shown that the voltage regulator device according to the present invention implements the objects set forth above.

The thus-devised voltage regulator device according to the present invention is anyhow susceptible of a number of modifications and variations, all of which falling within the same inventive concept; furthermore, all the details can be replaced by technically equivalent elements. In practice, the used materials, as well as the shaped and dimensions, will be able to be any, according to the technical needs.

Therefore, the protection scope of the invention is defined by the annexed claims.

1. A voltage regulator device, applicable to the electrical system of a motor vehicle of the type comprising at least one electrical machine consisting of a three-phase generator and at least an accumulator, the voltage regulator device comprising a rectifier bridge and a voltage rising circuit provided with a first series of power elements, characterized in that the voltage rising circuit comprises one or more inductors the winding inductance of stator phase of which is exploited in order to raise the phase voltage above the level of the voltage provided by the accumulator, so that it is possible to supply current to the electrical loads of the vehicle since a very low rotation regime of the engine of said vehicle.

2. The voltage regulator device according to claim 1, characterized in that said first series of power elements consists of three N channel field-effect transistors of the MOSFET type, wherein it is possible to use the respective wheeling diodes as rectifier elements and the channel closure in order to perform the regulating and raising voltage functions.

3. The voltage regulator device according to claim 1, characterized in that in the upper part of the rectifier bridge three diodes are present, the energy stored in the inductors further to the closing of a switch on the lower part of said rectifier bridge being returned to the opening of said switch as extra voltage that permits to trigger said three diodes to supply current towards the accumulator.

4. The voltage regulator device according to claim 1, characterized in that in the upper part of the rectifier bridge a second series of power elements is present, consisting of three N channel field-effect transistors of the MOSFET type, wherein it is possible to use the respective wheeling diodes as rectifier elements during the raising voltage phase.

5. The voltage regulator device according claim 1, characterized in that it is equipped with a microprocessor that generates the necessary driving for each series of power elements.

6. The voltage regulator device according to claim 5, characterized in that it is equipped with interface drivers specific for driving the upper part and the lower part of the rectifier bridge.

7. The voltage regulator device according to claim 5, characterized in that each series of power elements is driven by the microprocessor through a separate drive in the instant when the relative wheeling diode would come into direct conduction.

8. Driving method of a voltage regulator device according to claim 1, characterized in that it comprises the following phases:
if the voltage phase (V_{fase}_{_{—}}ₙ) in the voltage regulator device is greater than or equal to the positive potential (V_{batt}) of the accumulator, a first series of power elements is switched off, so as not to short-circuit said accumulator, and a second series of power elements is switched on, so that the current can flow from the three-phase generator towards said accumulator through a low resistance path as said second series of power elements, and not through the wheeling diodes;
if the voltage phase (V_{fase}_{_{—}}ₙ) in the voltage regulator device is lower than or equal to the negative potential (G_{batt}) of the accumulator, said second series of power elements is switched off, so as not to short-circuit said accumulator, and said first series of power elements is switched on, so that the current can flow from the three-phase generator towards said accumulator through a low resistance path as said first series of power elements, and not through the wheeling diodes.
